(19) United States
(12) Patent Application Publication
(10) Pub. No.: US 2024/0040394 A1
(43) Pub. Date: Feb. 1, 2024

(54) PLACING COMPONENTS FOR A VIRTUAL RADIO ACCESS NETWORK BASED ON RESOURCE AVAILABILITY AND PERFORMANCE

(71) Applicant: AT&T INTELLECTUAL PROPERTY I, L.P., Atlanta, GA (US)

(72) Inventors: Kartik Pandit, Aberdeen, NJ (US); Ashima Mangla, San Ramon, CA (US); Ricky Perry, Cumming, GA (US); Byoung-Jo Kim, Morganville, NJ (US)

(21) Appl. No.: 17/875,252

(22) Filed: Jul. 27, 2022

(51) Int. Cl. H04W 16/18

(52) U.S. Cl. CPC H04W 16/18

(57) ABSTRACT

The technologies described herein are generally directed to placing edge hub equipment for virtual radio access networks based on resource availability and performance in advanced networks, such as a fifth generation (5G) network or other next generation networks. For example, a method described herein can include receiving a request to select, for deployment of hub equipment, between site locations, with the deployment of the hub equipment being to connect, in a fronthaul segment, radio unit equipment of the network at a radio location to a backhaul connection equipment. The method can further include, based on the request, the radio location, and the backhaul location, comparing a characteristic of the site locations. Further, the method can include responding to the request with a selected site location that was selected based on a result of the comparing.

### TECHNICAL FIELD

The subject application is related to different approaches to handling communication in networked computer systems and, for example, to deploying network components in an advanced network, such as, but not limited to, at least a fifth generation communication network.

### BACKGROUND

As network implementations have continued to increase in size and diversity, approaches to reducing cost and improving performance have involved many different approaches. One approach divides functions across different network equipment of the network. Problems can occur when functions are migrated to locations where, contrary to intentions, costs are increased and performance is decreased due to increased connection distances.

### BRIEF DESCRIPTION OF THE DRAWINGS

The technology described herein is illustrated by way of example and not limited in the accompanying figures in which like reference numerals indicate similar elements and in which:

FIG. 1 is an architecture diagram of an example system that can utilize site selection equipment to place edge hub equipment for virtual radio access networks based on a request from hub implementation equipment, in accordance with one or more embodiments.

FIG. 2 is a diagram of a non-limiting example system that can facilitate selecting candidate locations for edge hub equipment to be utilized by site selection equipment, in accordance with one or more embodiments.

FIG. 3 is a diagram of a non-limiting example system that can facilitate selecting from candidate sites for placement of edge hub equipment, in accordance with one or more embodiments.

FIG. 4 depicts a diagram of a non-limiting example system that can facilitate selecting from candidate sites for placement of H1 hub equipment, in accordance with one or more embodiments.

FIG. 5 depicts a diagram of a non-limiting example system that can facilitate selecting from candidate sites for placement of H1 hub equipment, in accordance with one or more embodiments.

FIG. 6 illustrates an example method that can facilitate placing edge hub equipment for virtual radio access networks based on resource availability and performance, in accordance with one or more embodiments.

FIG. 7 depicts a system that can facilitate placing edge hub equipment for virtual radio access networks based on resource availability and performance, in accordance with one or more embodiments.

FIG. 8 depicts an example non-transitory machine-readable medium that can include executable instructions that, when executed by a processor of a system, facilitate placing edge hub equipment for virtual radio access networks based on resource availability and performance, in accordance with one or more embodiments described above.

FIG. 9 illustrates an example block diagram of an example mobile handset operable to engage in a system architecture that can facilitate processes described herein, in accordance with one or more embodiments.

FIG. 10 illustrates an example block diagram of an example computer operable to engage in a system architecture that can facilitate processes described herein, in accordance with one or more embodiments.

### DETAILED DESCRIPTION

Generally speaking, one or more embodiments of a system described herein can facilitate placing edge hub equipment for a virtual radio access network based on resource availability and performance. In addition, one or more embodiments described herein can be directed towards a multi-connectivity framework that supports the operation of new radio (NR, sometimes referred to as 5G). As will be understood, one or more embodiments can improve the structure of components of an advanced network implementation, by supporting control and mobility functionality on cellular links (e.g., long term evolution (LTE) or NR). One or more embodiments can provide benefits including system robustness, reduced overhead, and global resource management.

It should be understood that any of the examples and terms used herein are non-limiting. For instance, while examples are generally directed to non-standalone operation where the NR backhaul links are operating on millimeter wave (mmWave) bands and the control plane links are operating on sub-6 GHz long term evolution (LTE) bands, it should be understood that it is straightforward to extend the technology described herein to scenarios in which the sub-6 GHz anchor carrier providing control plane functionality could also be based on NR. As such, any of the examples herein are non-limiting examples, any of the embodiments, aspects, concepts, structures, functionalities or examples described herein are non-limiting, and the technology may be used in various ways that provide benefits and advantages in radio communications in general.

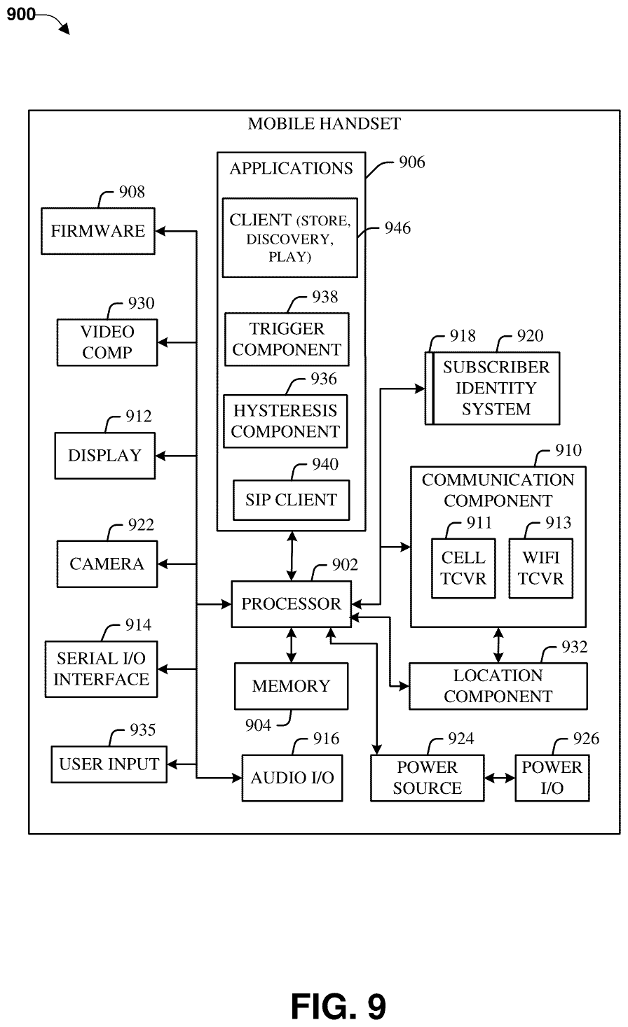

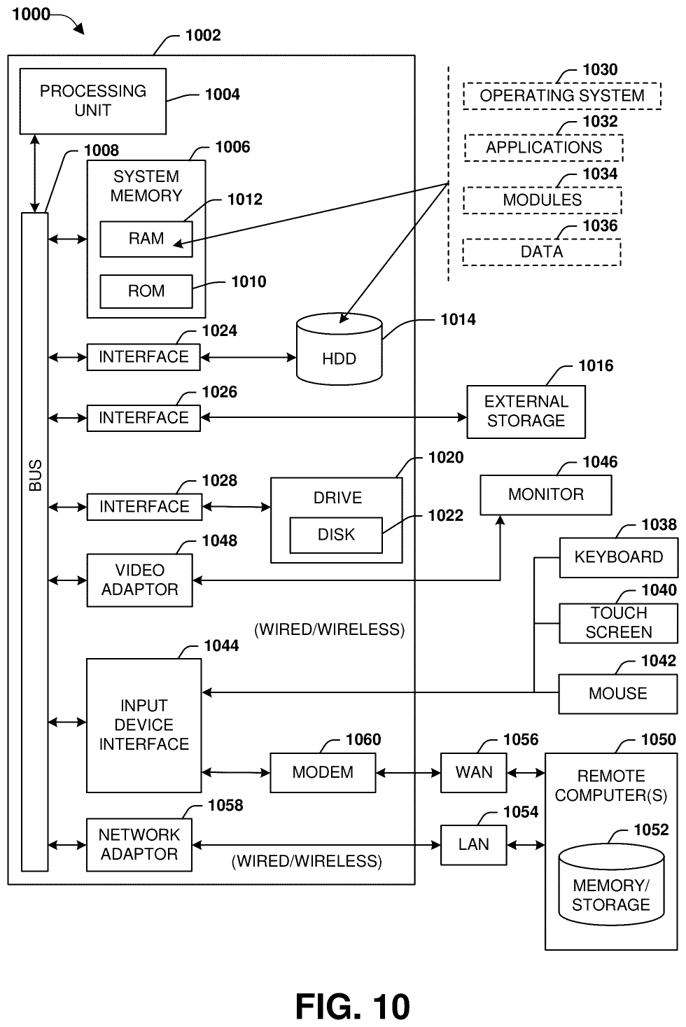

In some embodiments, understandable variations of the non-limiting term user equipment (UE) are used. This term can refer to any type of wireless device that can communicate with a radio network node in a cellular or mobile communication system. Examples of UEs include, but are not limited to, a target device, device to device (D2D) user equipment, machine type user equipment, user equipment capable of machine to machine (M2M) communication, PDAs, tablets, mobile terminals, smart phones, laptop embedded equipped (LEE), laptop mounted equipment (LME), USB dongles, and other equipment that can have similar connectivity. Example UEs are described further with FIGS. 9 and 10 below. Some embodiments are described in particular for 5G new radio systems. The embodiments are however applicable to any radio access technology (RAT) or multi-RAT system where the UEs operate using multiple carriers, e.g., LTE. Some embodiments are described in particular for 5G new radio systems. The embodiments are however applicable to any radio access technology (RAT) or multi-RAT system where the UEs operate using multiple carriers, e.g., LTE.

One having skill in the relevant art(s), given the disclosure herein understands that the computer processing systems, computer-implemented methods, equipment (apparatus) and/or computer program products described herein employ hardware and/or software to solve problems that are highly technical in nature (e.g., evaluating a combination of complex factors that include fiber optic propagation and virtualized network functions), that are not abstract and cannot be performed as a set of mental acts by a human. For example, a human, or even a plurality of humans, cannot efficiently select from candidate sites to employ network hub equipment with the same level of accuracy and/or efficiency as the various embodiments described herein.

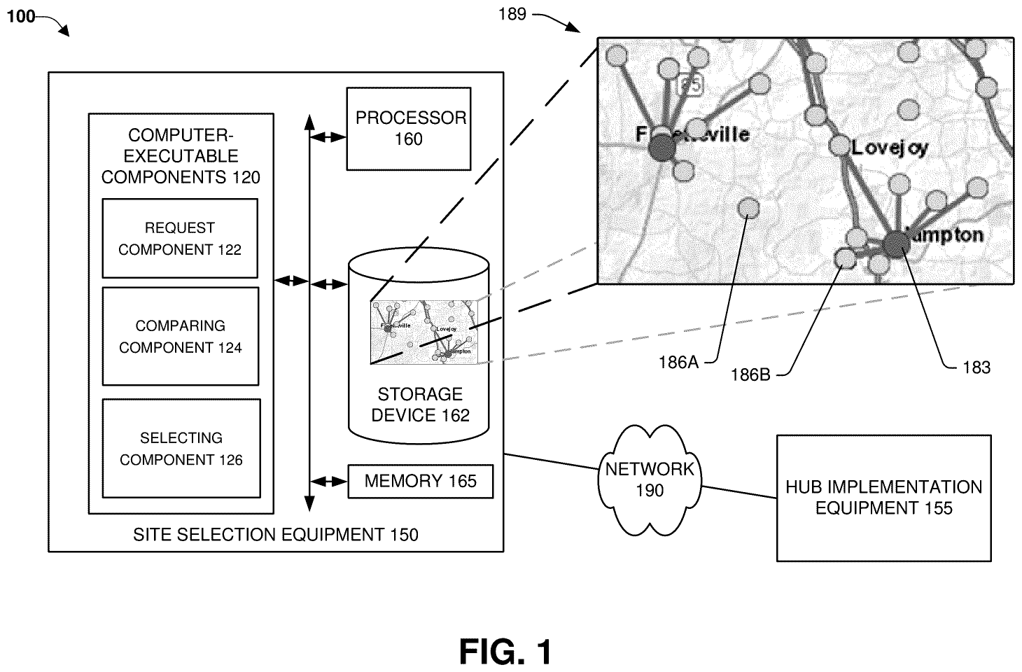

Aspects of the subject disclosure will now be described more fully hereinafter with reference to the accompanying drawings in which example components, graphs and selected operations are shown. In the following description, for purposes of explanation, numerous specific details are set forth in order to provide a thorough understanding of the various embodiments. For example, some embodiments described can facilitate placing edge hub equipment for virtual radio access networks based on resource availability and performance. Different examples that describe these aspects are included with the description of FIGS. 1-10 below. It should be noted that the subject disclosure may be embodied in many different forms and should not be construed as limited to this example or other examples set forth herein.

Generally speaking, one or more embodiments can select from candidate sites of network components to facilitate a disaggregated RAN where resources allocated for building the fronthaul network, midhaul transport, and the number of BBU/DU pools can be reduced, while meeting all the operational and capacity constraints imposed by the fronthaul and midhaul technologies.

FIG. 1 is an architecture diagram of an example system 100 that can utilize site selection equipment to place edge hub equipment for virtual radio access networks based on a request from hub implementation equipment 155, in accordance with one or more embodiments. For purposes of brevity, description of like elements and/or processes employed in other embodiments is omitted. As depicted, system 100 includes site selection equipment 150 connected to hub implementation equipment 155 via network 190, in accordance with one or more embodiments.

In one or more embodiments, site selection equipment 150 can include computer executable components 120, processor 160, storage device 162 and memory 165. Computer executable components 120 can include request component 122, comparing component 124, selecting component 126, and other components described or suggested by different embodiments described herein, that can improve the operation of system 100.

Further to the above, it should be appreciated that these components, as well as aspects of the embodiments of the subject disclosure depicted in this figure and various figures disclosed herein, are for illustration only, and as such, the architecture of such embodiments are not limited to the systems, devices, and/or components depicted therein. For example, in some embodiments, site selection equipment 150 can further comprise various computer and/or computing-based elements described herein with reference to mobile handset 900 of FIG. 9, and operating environment 1000 of FIG. 10. For example, one or more of the different functions of network equipment can be divided among various equipment, including, but not limited to, including equipment at a central node global control located on the core Network, e.g., mobile edge computing (MEC), self-organized networks (SON), or RAN intelligent controller (RIC) network equipment.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

According to multiple embodiments, storage device 162 can include, but is not limited to, RAM, ROM, EEPROM, flash memory or other memory technology, solid state drive (SSD) or other solid-state storage technology, Compact Disk Read Only Memory (CD ROM), digital video disk (DVD), blu-ray disk, or other optical disk storage, magnetic cassettes, magnetic tape, magnetic disk storage or other magnetic storage devices, or any other medium which can be used to store the desired information and which can be accessed by the computer. Storage device 162 is depicted as storing candidate map 189, having potential hub locations 186A-B (also termed ‘H1’ hubs, discussed below) and central office location 183 (also termed ‘H2’ hubs, discussed below).

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a system on a chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

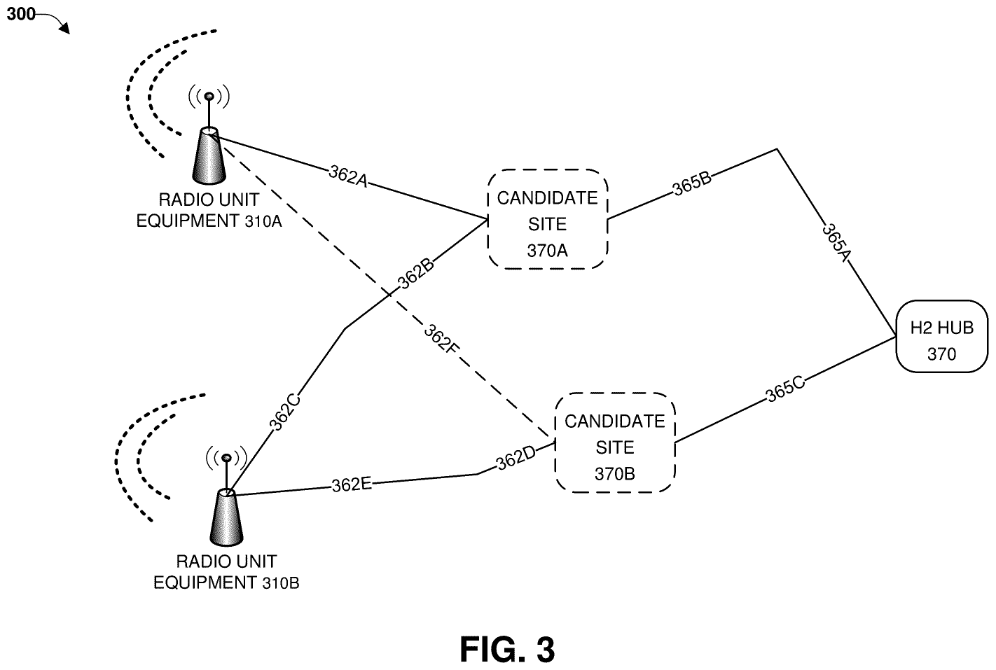

In one or more embodiments, computer executable components 120 can be used in connection with implementing one or more of the systems, devices, components, and/or computer-implemented operations shown and described in connection with FIG. 1 or other figures disclosed herein. For example, in one or more embodiments, computer executable components 120 can include instructions that, when executed by processor 160, can facilitate performance of operations defining request component 122. As discussed with FIGS. 3-5 below, request component 122 can, in accordance with one or more embodiments, receive a request to select, for deployment of hub equipment on a network, between site locations comprising a first site location and a second site location, wherein the network comprises a fronthaul segment connected via backhaul connection equipment at a backhaul location to a core network segment, and wherein the deployment of the hub equipment is to connect, in the fronthaul segment, radio unit equipment of the network at a radio location to the backhaul connection equipment.

Further, in another example, in one or more embodiments, computer executable components 120 can include instructions that, when executed by processor 160, can facilitate performance of operations defining comparing component 124. As discussed with FIGS. 3-5 below, comparing component 124 can, in accordance with one or more embodiments, based on the request, the radio location, and the backhaul location, compare a characteristic of the first site location and the second site location, resulting in a comparison of site locations.

In yet another example, computer executable components 120 can include instructions that, when executed by processor 160, can facilitate performance of operations defining selecting component 126. As discussed with FIGS. 3-5 below, in one or more embodiments, selecting component 126 can respond to the request with a selected site location that was selected based on a result of the comparing.

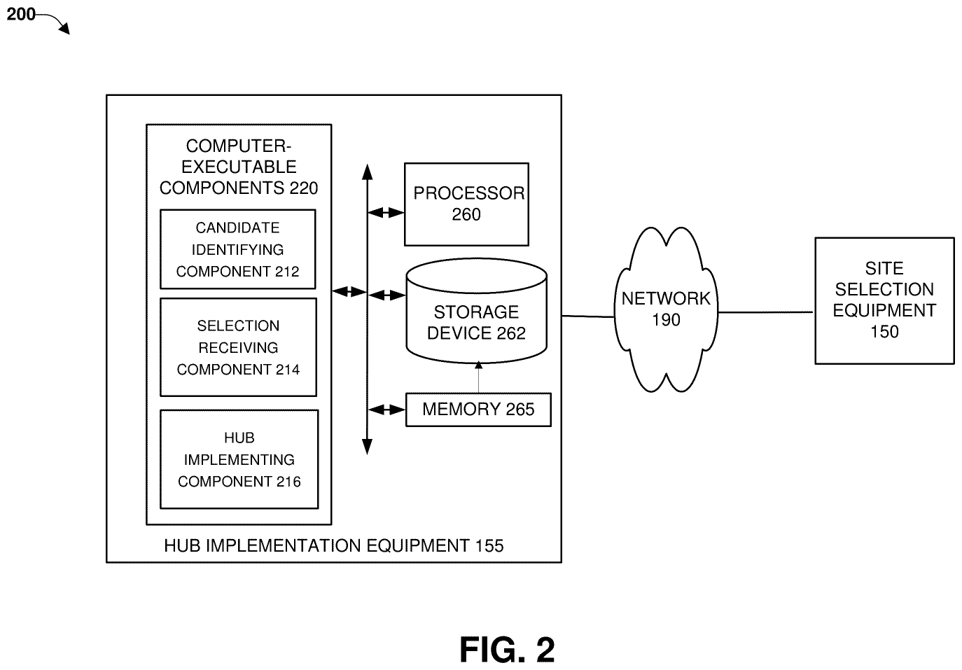

FIG. 2 is a diagram of a non-limiting example system 200 that can facilitate selecting candidate locations for edge hub equipment to be utilized by site selection equipment, in accordance with one or more embodiments. For purposes of brevity, description of like elements and/or processes employed in other embodiments is omitted.

As depicted, system 200 can include Hub implementation equipment 155 connected to site selection equipment 150 via network 190. In one or more embodiments, hub implementation equipment 155 can include memory 265 that can store one or more computer and/or machine readable, writable, and/or executable components and/or instructions 220 that, when respectively executed by processor 260, can facilitate performance of operations defined by the executable component(s) and/or instruction(s).

In system 200, computer executable components 220 can include candidate identifying component 212, selection receiving component 214, hub implementing component 216, and other components described or suggested by different embodiments described herein that can improve the operation of system 200. For example, in some embodiments, hub implementation equipment 155 can further comprise various computer and/or computing-based elements described herein with reference to mobile handset 900 of FIG. 9 and operating environment 1000 described with FIG. 10.

For example, in one or more embodiments, computer executable components 220 can be used in connection with implementing one or more of the systems, devices, components, and/or computer-implemented operations shown and described in connection with FIG. 2 or other figures disclosed herein. For example, in one or more embodiments, computer executable components 220 can include instructions that, when executed by processor 260, can facilitate performance of operations defining candidate identifying component 212. As discussed below, in one or more embodiments, candidate identifying component 212 can identify candidate locations for deployment of a group of distributed unit hub equipment within a network enabling coverage that spans a geographic area, wherein the network comprises remote radio access equipment to be connected to core network equipment via the group of distributed unit hub equipment deployed in selected locations of the candidate locations.

In another example, in one or more embodiments, computer executable components 220 can include instructions that, when executed by processor 260, can facilitate performance of operations defining selection receiving component 214. As discussed below, selection receiving component 214 can, in accordance with one or more embodiments, receive, from site selection equipment, a response to a request to select from the candidate locations according to a criterion based on respective locations of a group of remote radio access equipment, comprising the remote radio access equipment, and a core location corresponding to the core network equipment, the response comprising the selected locations for the deployment of the group of distributed unit hub equipment.

In another example, in one or more embodiments, computer executable components 220 can include instructions that, when executed by processor 260, can facilitate performance of operations defining hub implementing component 216. As discussed below, hub implementing component 216 can, in accordance with one or more embodiments, facilitate deploying the hub equipment at the selected site location.

FIG. 3 is a diagram of a non-limiting example system 300 that can facilitate selecting from candidate sites for placement of edge hub equipment (also termed H1 hubs herein), in accordance with one or more embodiments. For purposes of brevity, description of like elements and/or processes employed in other embodiments is omitted. As depicted, system 300 shows radio unit equipment 310A-B coupled to H2 hub 370A via one or more of candidate sites 370A-B.

Routes 362A-F represent either already placed (e.g., routes 362A-E) or potentially placed (e.g., route 362F) connection hardware routes between components depicted. In one or more embodiments, these routes can represent routes of fiber optic cables, with an associated cost for utilizing (routes 362A-E) or deploying and utilizing (route 362F). In addition, these routes, based in their characteristics (e.g., refractive index and length) can have associated estimated latency values. As discussed further below placements cost, maintenance cost, and transmission latency are non-limiting examples of values that can be used by embodiments to select from placement of components at one or more of candidate sites 370A-B.

With reference to radio unit equipment 310A-B, variations of the non-limiting terms “radio unit,” “remote radio unit (RRU),” “remote ratio head (RRH)” can all be used herein to describe different types of access points (AP), transmission points, transmission nodes, and nodes in distributed antenna system (DAS). Other concepts that would be suggested to one having skill in the relevant art(s), given the discussion of radio unit equipment 310A-B herein include, but are not limited to, “signal propagation source equipment” or simply “propagation equipment,” “radio network node” or simply “network node,” “radio network device.” These terms may be used interchangeably and refer to any type of network node that can serve user equipment and/or be connected to other network node or network element or any radio node from where user equipment can receive a signal.

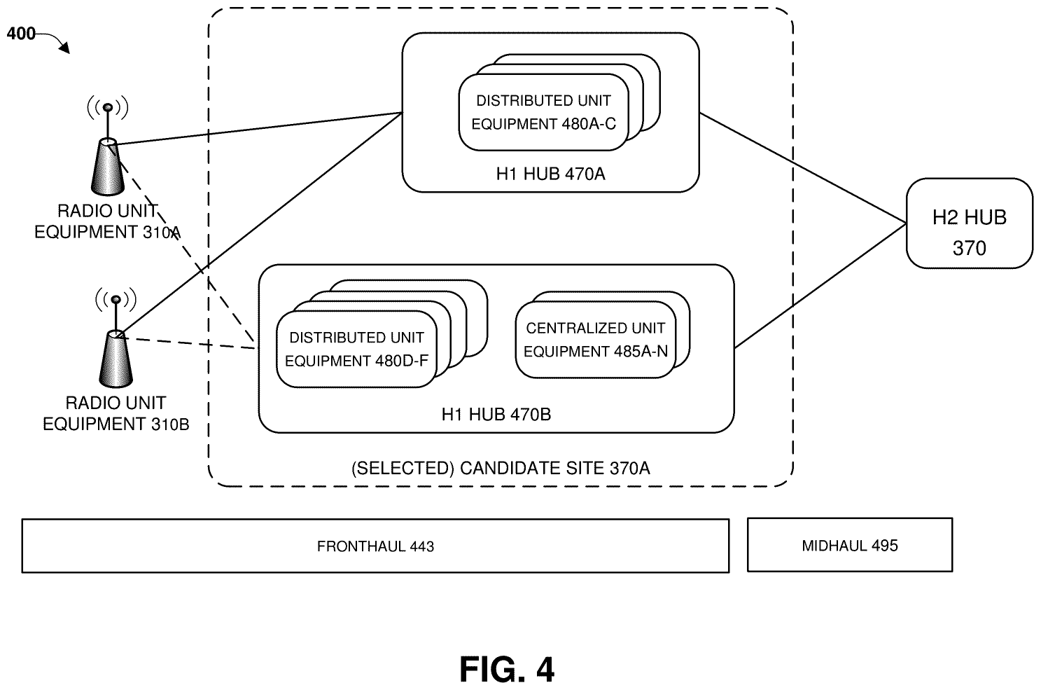

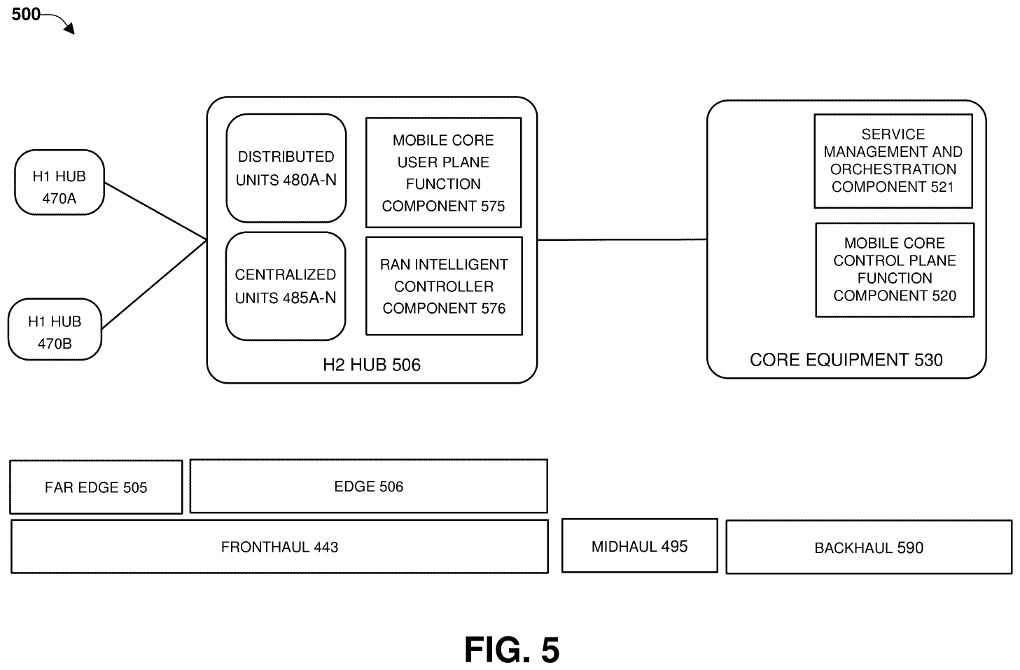

In many of the 5G examples discussed herein, gNode B (gNB) equipment is an example radio network node used for the depicted radio unit equipment 310A-B. Other examples of radio network node that can be used with some embodiments include, but are not limited to, base stations (BS), multi-standard radio (MSR) nodes such as MSR BS, eNode B (eNB), network controllers, radio network controllers (RNC), base station controllers (BSC), relays, donor node controlling relay, and base transceiver stations (BTS). As discussed further with FIGS. 4-5 below, H1 hub (not shown) and H2 hub 370, can be defined based on multiple macro cell radio unit equipment 310A-B being routed to a BBU/DU pool (herein referred to as H1 hubs), and with multiple BBU/DU pools being routed to a centralized unit, herein referred to as H2 hubs.

FIG. 4 depicts a diagram of a non-limiting example system 400 that can facilitate selecting from candidate sites for placement of H1 hub equipment, in accordance with one or more embodiments. For purposes of brevity, description of like elements and/or processes employed in other embodiments is omitted. As depicted, system 400 includes (selected) candidate site 370A, selected by site selection equipment 150, in accordance with one or more embodiments described herein. Placed at candidate site 370A, both H1 hubs 470A-B are coupled to H2 hub 370, and respectively include distributed unit equipment 480A-C and 480D-F, with H1 hub 470B including centralized unit equipment 485A-N. It should be noted that H1 hub 470B, by including both distributed unit equipment 480D-F and centralized unit equipment 485A-B can also be termed a base band unit/distributed unit (BBU/DU).

In one or more embodiments, the architecture of FIGS. 4-5 can disaggregate eNB/gNB equipment into the radio unit equipment 310A-B (also termed radio unit/remote radio head (RU/RRH) herein), distributed unit equipment 480A-C, and centralized unit equipment 485A-N. As depicted H1 hub 470B includes centralized unit equipment 485A-B and H1 hub 470A does not (with centralized unit equipment functions being disaggregated to H2 hub 370, discussed with FIG. 5 below.

In some implementations, this architecture can use a capacity and operations perspective to improve the efficiency of RAN design where radio unit equipment 310A-B can be connected via a fronthaul 443 connection to a pool of BBU/DUs (e.g., with H1 hub 470B having centralized unit equipment 485A-N). Alternatively, beneficial results can be achieved by using a midhaul 495 connection to use a pool of centralized unit equipment on H2 Hub 370 to provide centralized service functions distributed unit equipment 450A-C of H1 hub 470A.

One reason that system 400 can provide increased flexibility is that, by allowing the pooling of signal processing workloads in the BBU/DU, the centralized unit can provide support for the higher layers of the protocol stack (e.g., packet data convergence protocol (PDCP)), while the distributed unit can provide support for lower layers of the protocol stack (e.g., radio link control (RLC)), with this approach leading in some embodiments to increased multiplexing gain, reduced capacity needs, and simpler operations.

Additionally, in some implementations, pooling the BBU/DU processing resources among multiple macro radio unit equipment 310A-B and pooling the centralized resources among multiple DU/BBUs can leverage multiplexing gains of the RAN because of the special distribution of subscribers, e.g., improved design processes described herein can reduce the cost of hardware and software of the RAN, reduce operational complexity (e.g., because RAN equipment can be more centralized), and result in higher reliability than other approaches, e.g., because redundancies can be introduced to reduce or eliminate single points of failure.

One or more embodiments can achieve further increases in efficiency by selecting from candidate sites 370A-B where combinations of cost and performance can be estimated to be improved above threshold levels (or maximized). The following non-limiting formulas illustrate part of the implementation of one or more embodiments, and should not be considered to be descriptive of the operation of all aspects of embodiments. In the following formula, Usedij refers to whether hub j is used to service gNodeB i, distanceij refers to the distance between hub j and gNodeB i, and hub j refers to whether hub j was used.

Minimization objective: Σⱼ₌₁^{m}hubcostj*hubj+Σᵢ₌₁ⁿΣⱼ₌₁^{m}distanceij*Usedij

In an example implementation based on FIGS. 3-4, this formula describes a minimizing of cost for servicing radio unit equipment 310A by placing H1 hub 470A at either candidate site 370A or 370B, depending on the distance between candidate site 370A and the sites, e.g., a distance of route 362A and route 362F, respectively. In this example, distance is used to represent both cost (e.g., fiber expense can be linear based on distance) and performance (e.g., latency of a connection can be linear based on distance).

In different implementations, additional approaches that incorporate different fiber deployment costs, usage costs, and performance into account for different routes 362A-F. For example, because route 362F must be deployed before use, even though a distance associated with this route may be less than other routes, a deployment cost for route 362F can be added to the calculations to improve the cost estimate.

In addition, characteristics of the components used and tasks for the deployed components can be taken into account by embodiments. For example, specific conditions of an example implementation can include a latency maximum of 75 microseconds between radio unit equipment 310A and H1 hub 470A, with this value incorporating 50 microseconds for one-way transmission latency and 25 microseconds for latency at radio unit equipment 310A and distributed unit equipment 480A interfaces for protocol processing and switching. In some implementations, an additional constraint can include an application dictated roundtrip latency requirement of a maximum of 5-10 milliseconds for connections between H1 hub 470A to H2 hub 370. In some implementations there can be capacity constraints as to how much of radio unit equipment 310A-B can be routed to a H1 hub 470A, with an example H1 hub capacity (also termed ‘capacity’ herein) ranging from 20-50 macro sites of combined radio unit equipment 310A-B per H1 hub. As described below, constraints related to placement of the H1 hubs can be incorporated into the processes used by embodiments.

For example, when using distance to determine performance, one or more embodiments can place constraints on the level of performance provided by a candidate site, e.g., in the pseudocode below, the latency constraint ca be translated to a fiber distance constraint as follows: 50 (microseconds)/5 microseconds=10 km maximum distance for solid core fiber and a 15 km maximum distance for hollow core fiber is used. In a fronthaul connection (e.g., fiber used from radio unit equipment 310A to H2 hub 370) this maximum distance can be termed dafibound miles.

As another type of constraint, there can be redundancy constraints such as macro radio units having a requirement to be routed to a backup H1 hub, or an H1 hub routed to a backup H2 hub in case of failure. For example, in one or more embodiments a request by hub implementation equipment 155 can include a request for site selection that includes a redundant site location for deployment of redundant hub equipment for other hub equipment also selected. Thus, in this example, candidate site 370A can be selected for deployment of the H1 hub and candidate site 370B can be selected for deployment of a redundant, backup H1 hub for the main H1 hub.

In the following pseudocode, H1_list is the set of candidate H1 hubs and f_j is the cost of using hub j. In some implementations, hubs are implemented in the central office sites and there is a cost associated with prepping the site for the vRAN BBU/DU pools such as power, space cooling+the hardware and software. H2_list is the set of candidate H2 hubs and h_k is a cost associated with prepping site (or hub) k in H2_list. In one or more embodiments, there can also be a cost of building transport from the macro radio unit sites to the H1 hubs and the H1 hub transport cost to the H2 hubs, e.g., the cost of installing, testing and operating fiber optic connections for the H1 hubs transport, and switched ethernet for the H2 hub transport.

Continuing the variables, c_ij is the cost of routing fronthaul traffic from macro radio unit site i in gnB_list to H1 hub j, and d_jk is the cost of routing midhaul traffic from H1 hub j to H2 hub k, e.g., this cost being approximately proportional to the distance for both fronthaul and midhaul. In addition, one or more embodiments can use optimization variables to change different conditions. For example, variables x_ij, y_j, z_k and w_jk have the following encoding: x_ij is set to 1 if macro RU i is mapped to H1 hub j, 0 otherwise, w_jk is set to 1 if H1 hub j is mapped to H2 hub k, 0 otherwise, y_j is set to 1 if H1 hub j is utilized, 0 otherwise, and z_k is set to 1 if H2 hub k is set to 1, 0 otherwise. Additional constraints are listed and explained below.

This is a demand constraint which forces the LP to map all RU macro sites to one H1 hub: Eⱼ^{j∈H1_list} x_{i,j}==dᵢ∀i∈gNB_list

This is a capacity constraint that forces a maximum capacity on the number of RU macros that can be mapped to a H1 hub. This can be set to 20-50 but implementations can vary depending on conditions: Eᵢ^{i∈gNB_list} x_{i,j}≤capacityⱼ*yⱼ∀j∈H1_list

This forces H1 hub j to be utilized if x_ij is activated:

x_{i,j}≤dᵢ*yⱼ∀i in gNB_list,∀j in H1_list

This is a demand constraint on the H1 hub to H2 hub mapping that forces the mapping of all activated H1 hubs, e.g., this can be set to 1 if no redundancy is required or 2 if redundancy is needed to meet reliability SLAs. Σₖ^{k∈H2_list} w_{j,k}≤eⱼ∀j∈H1_list

This is a capacity constraint on H2 hubs:

Σⱼ^{j∈H1}^{ₗᵢₛₜ}w_{j,k}≤H2capacityₖ*zₖ∀k∈H2_list

This is a flow constraint that forces all activated H1 hubs to be mapped to a H2 hub:

Σᵢ^{i∈gNB_list}x_{i,j}≤110*ΣEₖ^{k∈H2}^{ₗᵢₛₜ}w_{j,k}∀j∈H1_list

This is a latency constraint:

c_{i,j}*x_{i,j}−dafiboundmiles*x_{i,j}≤0∀i∈gNB_list,∀j∈H1_list

Based on the foregoing variables, the following pseudocode describes a process that can be used by one or more embodiments to select sites for deployment of H1 hubs:

Minimize: 1pSum(f_j[j]*y_j[j] for j in H1_list)+1pSum(c_ji[j][i]*x_ij[(i,j)] for j in H1_list for i in gNB_list)+

Minimization objective: Σⱼ₌₁^{m}hubcostj*hubj+Σᵢ₌₁ⁿΣⱼ₌₁^{m}distanceij*Usedij

1pSum(h_k[k]*z_k[k] for k in H2_list)+1pSum(d_jk[k][J]*w_jk[(J,k)] for J in H1_list for k in H2_list)

Minimization objective: Σⱼ₌₁^{m}hubcostj*hubj+Σᵢ₌₁ⁿΣⱼ₌₁^{m}distanceij*Usedij

FIG. 5 depicts a diagram of a non-limiting example system 500 that can facilitate selecting from candidate sites for placement of H1 hub equipment, in accordance with one or more embodiments. For purposes of brevity, description of like elements and/or processes employed in other embodiments is omitted. As depicted, system 500 shows an example deployment of H1 hubs 470A-B served by H2 hub 506, with H2 hub 506 being connected (via a connection labeled as midhaul 595) to core equipment 530 (also termed backhaul equipment at a backhaul location, herein).

Labeled in the figure, H1 hubs 470A-B and H2 hub 506 are labeled as edge equipment, with H1 hubs 470A-B being labeled as being on the far edge 505 and H2 hub being labeled as on edge 506. As further highlighted, the edge equipment are labeled as being a part of a fronthaul 543 part of the network. H2 hub includes distributed units 480A-N, centralized unit equipment 485A-N, mobile core user plane function component 575, and RAN intelligent controller component 576. Core equipment 530 is depicted in the backhaul 590 portion of the network and as having service management and orchestration component 521 and mobile core control plane function component 520.

As discussed above, to implement the disaggregated architecture the centralized unit equipment 485A-N equipment can perform functions that include mobile core user plane function component 575 and RAN intelligent controller component 576.

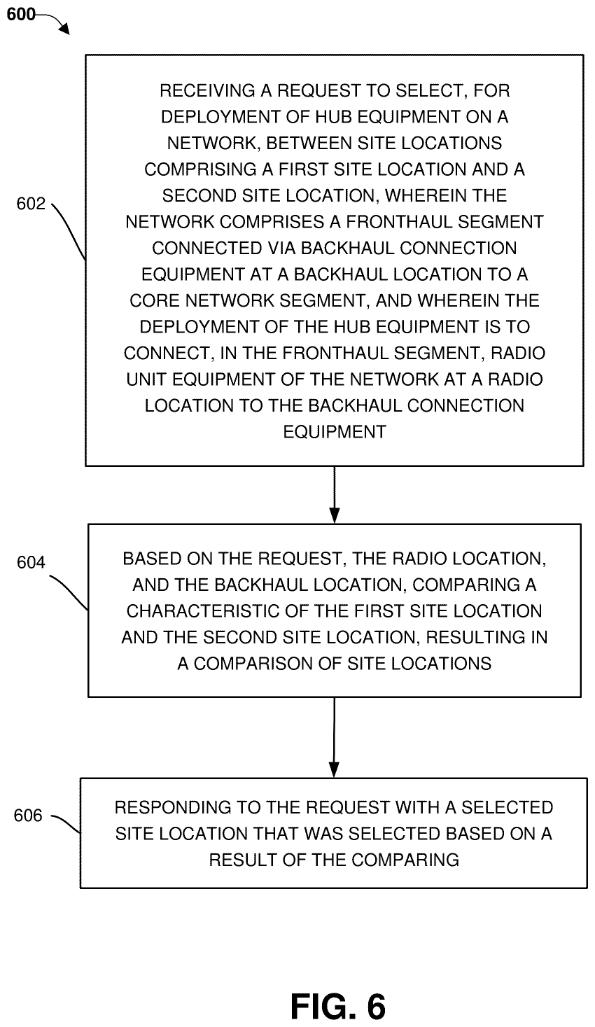

FIG. 6 illustrates an example method 600 that can facilitate placing edge hub equipment for virtual radio access networks based on resource availability and performance, in accordance with one or more embodiments. For purposes of brevity, description of like elements and/or processes employed in other embodiments is omitted.

At 602, method 600 can include receiving a request to select, for deployment of hub equipment on a network, between site locations that can include a first site location and a second site location, the network comprises a fronthaul segment connected via backhaul connection equipment at a backhaul location to a core network segment, and the deployment of the hub equipment is to connect, in the fronthaul segment, radio unit equipment of the network at a radio location to the backhaul connection equipment. An example can include receiving a request from hub implementation equipment 155 to select, for deployment of H1 hub 470A, between site locations that can include candidate sites 370A-B, with the network including a fronthaul 443 segment connected via core equipment 530 and backhaul 590. In this example, radio unit equipment 310A-B can be connected to core equipment 530 via H1 hub 470A and H2 hub 506.

At 604, method 600 can include, based on the request, the radio location, and the backhaul location, comparing a characteristic of the first site location and the second site location, resulting in a comparison of site locations. Continuing the example above, based on the request, the radio location, and the backhaul location, a characteristic of the candidate sites 370A-B can be compared.

At 606, method 600 can include responding to the request with a selected site location that was selected based on a result of the comparing. The example method can further include site selection equipment 150 responding to the request with a selected site location that was selected based on a result of the comparing.

In additional or alternative embodiments, the radio unit equipment can include a remote radio unit that can be remote from the system.

In additional or alternative embodiments, the hub equipment can include distributed unit equipment, and the distributed unit equipment can be connected to the backhaul connection equipment via central unit equipment.

In additional or alternative embodiments, the central unit equipment is to be deployed with the hub equipment at the selected site location.

In additional or alternative embodiments, the central unit equipment was deployed at a central unit location different from the site locations, the characteristic further can include an estimated cost representative of respective estimated costs of connecting the first site location and the second site location to the central unit equipment, and the estimated costs are determined relative to the central unit location.

In additional or alternative embodiments, a segment connecting the distributed unit equipment to the central unit equipment can include a midhaul segment linking the fronthaul segment to the backhaul connection equipment.

In additional or alternative embodiments, central unit equipment performs functions that include a mobile core user plane function.

In additional or alternative embodiments, the central unit equipment can include radio access network intelligent controller equipment.

In additional or alternative embodiments, the characteristic can include a latency value determined based on respective latencies corresponding to a first estimated latency of a first communication between the first site location and the radio unit equipment and a second estimated latency of a second communication between the second site location and the radio unit equipment.

In additional or alternative embodiments, the first estimated latency can be determined based on a first factor that can include a first distance corresponding to a first connection distance of a first connection between the radio location and the first site location, and the second estimated latency can be determined based on a second factor that can include a second distance corresponding to a second connection distance of a second connection between the radio location and the second site location.

In additional or alternative embodiments, the characteristic further can include an estimated cost representative of respective estimated costs, respectively determined based on the first distance, for connecting the hub equipment at the first site location to the radio unit equipment and determined based on the second distance, for connecting the hub equipment at the second site location to the radio unit equipment.

In additional or alternative embodiments, at least one of the first connection or the second connection can include a fiber optic connection, and the latency value can be further determined based on a refractive index of the fiber optic connection.

In additional or alternative embodiments, the hub equipment can be first hub equipment, the radio unit equipment can be first radio unit equipment, and the characteristic further can include respective estimates, for respective site locations, of third site locations for second hub equipment determined to be implicated to connect second radio unit equipment to the backhaul connection equipment.

Additional or alternative embodiments can further include facilitating, by the system, deploying the hub equipment at the selected site location, and establishing, by the system, a virtual radio access network by linking functions of the radio unit equipment and the hub equipment.

In additional or alternative embodiments, the request further can include a request to select a redundant site location for deployment of redundant hub equipment for the hub equipment, and the request further specifies selecting from among the first site location, the second site location, and a third site location.

In additional or alternative embodiments, the hub equipment can include distributed unit equipment implemented in accordance with at least a fifth generation communication network protocol.

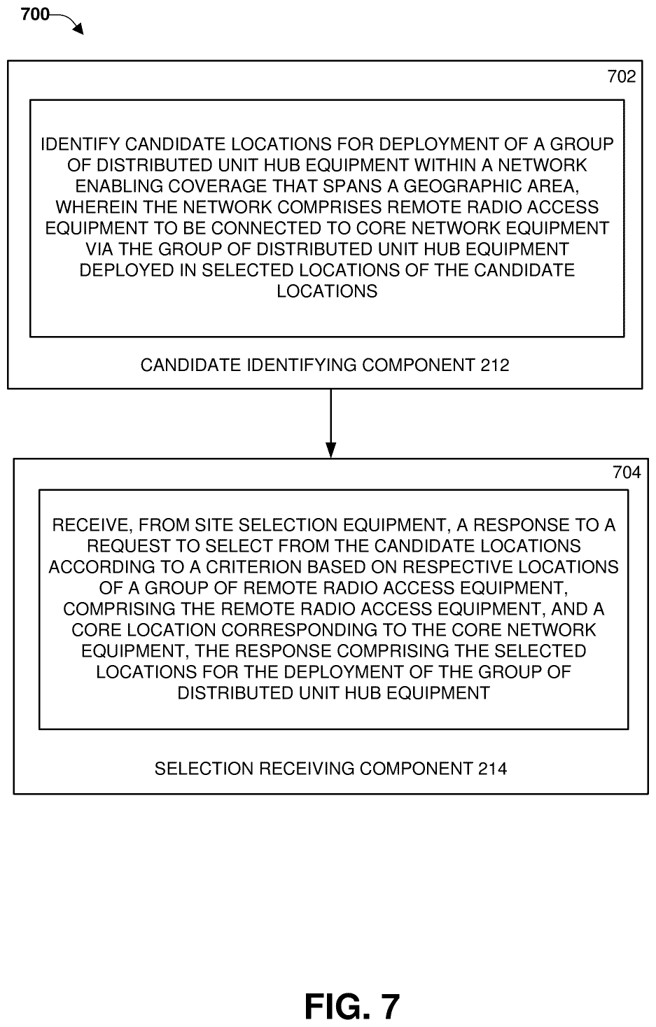

FIG. 7 depicts a system 700 that can facilitate placing edge hub equipment for virtual radio access networks based on resource availability and performance, in accordance with one or more embodiments. For purposes of brevity, description of like elements and/or processes employed in other embodiments is omitted. As depicted, system 700 can include candidate identifying component 212, selection receiving component 214, and other components described or suggested by different embodiments described herein, that can improve the operation of system 700.

In an example, component 702 can include the functions of candidate identifying component 212, supported by the other layers of system 700. For example, component 702 can identify candidate locations for deployment of a group of distributed unit hub equipment within a network enabling coverage that spans a geographic area, wherein the network comprises remote radio access equipment to be connected to core network equipment via the group of distributed unit hub equipment deployed in selected locations of the candidate locations.

In this and other examples, component 704 can include the functions of selection receiving component 214, supported by the other layers of system 700. Continuing this example, in one or more embodiments, component 704 can receive, from site selection equipment, a response to a request to select from the candidate locations according to a criterion based on respective locations of a group of remote radio access equipment, comprising the remote radio access equipment, and a core location corresponding to the core network equipment, the response comprising the selected locations for the deployment of the group of distributed unit hub equipment.

In additional or alternative embodiments, the criterion can be further based on performance requirements for the group of distributed unit hub equipment deployed at the selected locations.

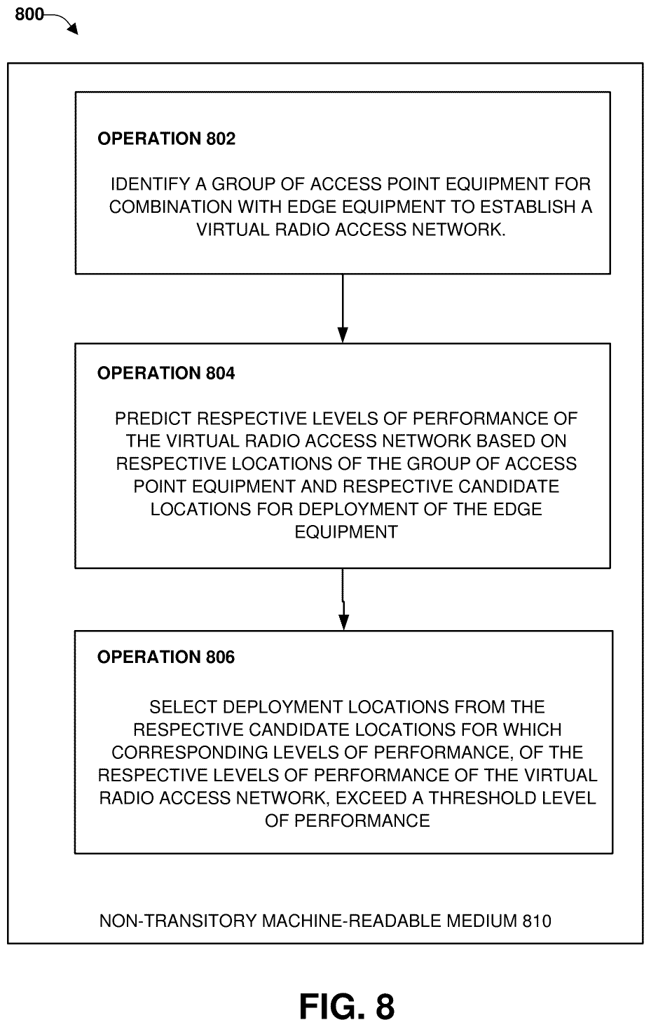

FIG. 8 depicts an example 800 non-transitory machine-readable medium 810 that can include executable instructions that, when executed by a processor of a system, facilitate placing edge hub equipment for virtual radio access networks based on resource availability and performance, in accordance with one or more embodiments described above. For purposes of brevity, description of like elements and/or processes employed in other embodiments is omitted. As depicted, non-transitory machine-readable medium 810 includes executable instructions that can facilitate performance of operations 802-806.

In one or more embodiments, the operations can include operation 802 that can identify candidate locations for deployment of a group of distributed unit hub equipment within a network enabling coverage that spans a geographic area, wherein the network comprises remote radio access equipment to be connected to core network equipment via the group of distributed unit hub equipment deployed in selected locations of the candidate locations.

In one or more embodiments, the operations can include operation 802 that can identify a group of access point equipment for combination with edge equipment to establish a virtual radio access network.

In one or more embodiments, the operations can further include operation 804 that can predict respective levels of performance of the virtual radio access network based on respective locations of the group of access point equipment and respective candidate locations for deployment of the edge equipment.

In one or more embodiments, the operations can further include operation 806 that can select deployment locations from the respective candidate locations for which corresponding levels of performance, of the respective levels of performance of the virtual radio access network, exceed a threshold level of performance.

In additional or alternative embodiments, selecting the deployment locations can be further based on a predicted cost determined based on respective predicted costs of the deployment and maintenance of the edge equipment at the respective candidate locations.

FIG. 9 illustrates an example block diagram of an example mobile handset 900 operable to engage in a system architecture that facilitates wireless communications according to one or more embodiments described herein. Although a mobile handset is illustrated herein, it will be understood that other devices can be a mobile device, and that the mobile handset is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media

The handset includes a processor 902 for controlling and processing all onboard operations and functions. A memory 904 interfaces to the processor 902 for storage of data and one or more applications 906 (e.g., a video player software, user feedback component software, etc.). Other applications can include voice recognition of predetermined voice commands that facilitate initiation of the user feedback signals. The applications 906 can be stored in the memory 904 and/or in a firmware 908, and executed by the processor 902 from either or both the memory 904 or/and the firmware 908. The firmware 908 can also store startup code for execution in initializing the handset 900. A communications component 910 interfaces to the processor 902 to facilitate wired/wireless communication with external systems, e.g., cellular networks, VoIP networks, and so on. Here, the communications component 910 can also include a suitable cellular transceiver 911 (e.g., a GSM transceiver) and/or an unlicensed transceiver 913 (e.g., Wi-Fi, WiMax) for corresponding signal communications. The handset 900 can be a device such as a cellular telephone, a PDA with mobile communications capabilities, and messaging-centric devices. The communications component 910 also facilitates communications reception from terrestrial radio networks (e.g., broadcast), digital satellite radio networks, and Internet-based radio services networks

The handset 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor 902 to facilitate wired and/or wireless serial communications (e.g., USB, and/or IEEE 1294) through a hardwire connection, and other serial input devices (e.g., a keyboard, keypad, and mouse). This supports updating and troubleshooting the handset 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The handset 900 can include a slot interface 918 for accommodating a SIC (Subscriber Identity Component) in the form factor of a card SIM or universal SIM 920, and interfacing the SIM card 920 with the processor 902. However, it is to be appreciated that the SIM card 920 can be manufactured into the handset 900, and updated by downloading data and software.

The handset 900 can process IP data traffic through the communications component 910 to accommodate IP traffic from an IP network such as, for example, the Internet, a corporate intranet, a home network, a person area network, etc., through an ISP or broadband cable provider. Thus, VoIP traffic can be utilized by the handset 900 and IP-based multimedia content can be received in either an encoded or a decoded format.

A video processing component 922 (e.g., a camera) can be provided for decoding encoded multimedia content. The video processing component 922 can aid in facilitating the generation, editing, and sharing of video quotes. The handset 900 also includes a power source 924 in the form of batteries and/or an AC power subsystem, which power source 924 can interface to an external power system or charging equipment (not shown) by a power I/O component 926.

The handset 900 can also include a video component 930 for processing video content received and, for recording and transmitting video content. For example, the video component 930 can facilitate the generation, editing and sharing of video quotes. A location tracking component 932 facilitates geographically locating the handset 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touch screen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 936 when the Wi-Fi transceiver 913 detects the beacon of the access point. A SIP client 940 enables the handset 900 to support SIP protocols and register the subscriber with the SIP registrar server. The applications 906 can also include a client 942 that provides at least the capability of discovery, play and store of multimedia content, for example, music.

The handset 900, as indicated above related to the communications component 910, includes an indoor network radio transceiver 913 (e.g., Wi-Fi transceiver). This function supports the indoor radio link, such as IEEE 802.11, for the dual-mode GSM handset 900. The handset 900 can accommodate at least satellite radio services through a handset that can combine wireless voice and digital radio chipsets into a single handheld device.

Network 190 can employ various cellular systems, technologies, and modulation schemes to facilitate wireless radio communications between devices. While example embodiments include use of 5G new radio (NR) systems, one or more embodiments discussed herein can be applicable to any radio access technology (RAT) or multi-RAT system, including where user equipment operate using multiple carriers, e.g., LTE FDD/TDD, GSM/GERAN, CDMA2000, etc. For example, wireless communication system 200 can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system 100 are particularly described wherein the devices of system 100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the user equipment. The term carrier aggregation (CA) is also called (e.g., interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

Various embodiments described herein can be configured to provide and employ 5G wireless networking features and functionalities. With 5G networks that may use waveforms that split the bandwidth into several sub bands, different types of services can be accommodated in different sub bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

FIG. 10 provides additional context for various embodiments described herein, intended to provide a brief, general description of a suitable operating environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example operating environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid-state drive, an optical disk drive, which can read or write from a disk 1022, such as a CD-ROM disc, a DVD, a BD, etc. Alternatively, where a solid-state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further to the description above, as it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine-readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment do not normally connect directly to the core networks of a large service provider, but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

While the various embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope of the various embodiments.

In addition to the various implementations described herein, it is to be understood that other similar implementations can be used, or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be affected across a plurality of devices. Accordingly, the embodiments are not to be limited to any single implementation, but rather are to be construed in breadth, spirit and scope in accordance with the appended claims.

What is claimed is:

1. A method, comprising:
receiving, by a system comprising a processor, a request to select, for deployment of hub equipment on a network, between site locations comprising a first site location and a second site location, wherein the network comprises a fronthaul segment connected via backhaul connection equipment at a backhaul location to a core network segment, and wherein the deployment of the hub equipment is to connect, in the fronthaul segment, radio unit equipment of the network at a radio location to the backhaul connection equipment;
based on the request, the radio location, and the backhaul location, comparing, by the system, a characteristic of the first site location and the second site location, resulting in a comparison of site locations; and
responding, by the system, to the request with a selected site location that was selected based on a result of the comparing.

2. The method of claim 1, wherein the radio unit equipment comprises a remote radio unit that is remote from the system.

3. The method of claim 1, wherein the hub equipment comprises distributed unit equipment, and wherein the distributed unit equipment is connected to the backhaul connection equipment via central unit equipment.

4. The method of claim 3, wherein the central unit equipment is to be deployed with the hub equipment at the selected site location.

5. The method of claim 3, wherein the central unit equipment was deployed at a central unit location different from the site locations, wherein the characteristic further comprises an estimated cost representative of respective estimated costs of connecting the first site location and the second site location to the central unit equipment, and wherein the estimated costs are determined relative to the central unit location.

6. The method of claim 3, wherein a segment connecting the distributed unit equipment to the central unit equipment comprises a midhaul segment linking the fronthaul segment to the backhaul connection equipment.

7. The method of claim 3, wherein the central unit equipment performs functions comprising a mobile core user plane function.

8. The method of claim 3, wherein the central unit equipment comprises radio access network intelligent controller equipment.

9. The method of claim 1, wherein the characteristic comprises a latency value determined based on respective latencies corresponding to a first estimated latency of a first communication between the first site location and the radio unit equipment and a second estimated latency of a second communication between the second site location and the radio unit equipment.

10. The method of claim 9, wherein the first estimated latency is determined based on a first factor comprising a first distance corresponding to a first connection distance of a first connection between the radio location and the first site location, and wherein the second estimated latency is determined based on a second factor comprising a second distance corresponding to a second connection distance of a second connection between the radio location and the second site location.

11. The method of claim 10, wherein the characteristic further comprises an estimated cost representative of respective estimated costs, respectively determined based on the first distance, for connecting the hub equipment at the first site location to the radio unit equipment and determined based on the second distance, for connecting the hub equipment at the second site location to the radio unit equipment.

12. The method of claim 10, wherein at least one of the first connection or the second connection comprises a fiber optic connection, and wherein the latency value is further determined based on a refractive index of the fiber optic connection.

13. The method of claim 1, wherein the hub equipment is first hub equipment, wherein the radio unit equipment is first radio unit equipment, and wherein the characteristic further comprises respective estimates, for respective site locations, of third site locations for second hub equipment determined to be implicated to connect second radio unit equipment to the backhaul connection equipment.

14. The method of claim 1, further comprising:
facilitating, by the system, deploying the hub equipment at the selected site location; and
establishing, by the system, a virtual radio access network by linking functions of the radio unit equipment and the hub equipment.

15. The method of claim 1, wherein the request further comprises a request to select a redundant site location for deployment of redundant hub equipment for the hub equipment, and wherein the request further specifies selecting from among the first site location, the second site location, and a third site location.

16. The method of claim 1, wherein the hub equipment comprises distributed unit equipment implemented in accordance with at least a fifth generation communication network protocol.

17. A system, comprising:
a processor; and
a memory that stores executable instructions that, when executed by the processor, facilitate performance of operations, comprising:
identifying candidate locations for deployment of a group of distributed unit hub equipment within a network enabling coverage that spans a geographic area, wherein the network comprises remote radio access equipment to be connected to core network equipment via the group of distributed unit hub equipment deployed in selected locations of the candidate locations; and
receiving, from site selection equipment, a response to a request to select from the candidate locations according to a criterion based on respective locations of a group of remote radio access equipment, comprising the remote radio access equipment, and a core location corresponding to the core network equipment, the response comprising the selected locations for the deployment of the group of distributed unit hub equipment.

18. The system of claim 17, wherein the criterion is further based on performance requirements for the group of distributed unit hub equipment deployed at the selected locations.

19. A non-transitory machine-readable medium, comprising executable instructions that, when executed by a processor of a site selection device, facilitate performance of operations, comprising:
identifying a group of access point equipment for combination with edge equipment to establish a virtual radio access network;
predicting respective levels of performance of the virtual radio access network based on respective locations of the group of access point equipment and respective candidate locations for deployment of the edge equipment; and
selecting deployment locations from the respective candidate locations for which corresponding levels of performance, of the respective levels of performance of the virtual radio access network, exceed a threshold level of performance.

20. The non-transitory machine-readable medium of claim 19, wherein selecting the deployment locations is further based on a predicted cost determined based on respective predicted costs of the deployment and maintenance of the edge equipment at the respective candidate locations.
